(19) United States
(12) Patent Application Publication
(10) Pub. No.: US 2025/0061336 A1
(43) Pub. Date: Feb. 20, 2025

(54) INFORMATION PROCESSING APPARATUS, INFORMATION PROCESSING METHOD, AND COMPUTER PROGRAM PRODUCT

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Masaaki TAKADA, Kashiwa (JP); Gen LI, Kawasaki (JP); Yasuhisa OOMURO, Komatsu (JP); Kazuya KIKUCHI, Kanazawa (JP); Xueting WANG, Nomi (JP); Takumi ITO, Nonoichi (JP); Kozo KINOSHITA, Fujisawa (JP); Toshiki SHIBANO, Kawasaki (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 18/592,012

(22) Filed: Feb. 29, 2024

(30) Foreign Application Priority Data
Aug. 14, 2023 (JP) 2023-131894

(51) Int. Cl. G06N 3/09

(52) U.S. Cl. CPC G06N 3/09

(57) ABSTRACT

According to an embodiment, an information processing apparatus includes a processing unit configured to: detect whether or not one or more conditions defining timings to perform learning of a regression model configured to predict one or more objective variables for a plurality of explanatory variables are satisfied; determine priorities of the plurality of explanatory variables according to a condition detected to be satisfied; and perform learning of the regression model by using an objective function and learning data, the objective function including a regularization term having a regularization strength changing according to the priorities.

### CROSS-REFERENCE TO RELATED APPLICATIONS

This application is based upon and claims the benefit of priority from Japanese Patent Application No. 2023-131894, filed on Aug. 14, 2023; the entire contents of which are incorporated herein by reference.

### FIELD

Embodiments described herein relate generally to an information processing apparatus, an information processing method, and a computer program product.

### BACKGROUND

In factories (semiconductor factories and the like) and plants (chemical plants and the like), monitoring of quality characteristics, grasping of tendency changes or abnormalities, examination of countermeasures, and the like are executed by utilizing big data regarding manufacturing to improve productivity, yield, and reliability.

For example, a regression model is used as an analysis method of big data. The regression model is, for example, a model in which process data such as a sensor value, a control value, and a setting value is used as an explanatory variable and a quality characteristic is used as an objective variable. In factories and plants, it may be necessary to update a regression model according to an event such as maintenance of equipment, a change in trend of process data, and the like, and it is desired to efficiently manage the regression model.

### BRIEF DESCRIPTION OF THE DRAWINGS

FIG. 1 is a block diagram of an information processing apparatus according to an embodiment;

FIG. 2 is a diagram illustrating an example of a data structure of event information;

FIG. 3 is a diagram illustrating an example of a data structure of correspondence information;

FIG. 4 is a diagram illustrating an example of a data structure of sensor data;

FIG. 5 is a diagram for explaining an example of measurement points;

FIG. 6 is a diagram illustrating an example of weights;

FIG. 7 is a flowchart of learning processing according to the embodiment;

FIG. 8 is a diagram illustrating an example of a data structure of sensor data;

FIG. 9 is a diagram illustrating an example of a data structure of event information;

FIG. 10 is a diagram illustrating an example of a data structure of correspondence information; and

FIG. 11 is a hardware configuration diagram of the information processing apparatus according to the embodiment.

### DETAILED DESCRIPTION

According to an embodiment, an information processing apparatus includes a processing unit configured to: detect whether or not one or more conditions defining timings to perform learning of a regression model configured to predict one or more objective variables for a plurality of explanatory variables are satisfied; determine priorities of the plurality of explanatory variables according to a condition detected to be satisfied; and perform learning of the regression model by using an objective function and learning data, the objective function including a regularization term having a regularization strength changing according to the priorities.

Hereinafter, a preferred embodiment of an information processing apparatus according to the present invention will be described in detail with reference to the accompanying drawings.

The information processing apparatus of the present embodiment can be applied to, for example, management (including construction, updating, learning, etc.) of a model used in a system that performs quality management in factories and plants. Applicable systems are not limited thereto.

In factories, plants, and the like, a regression model is utilized for the following four applications, for example, in order to improve productivity, yield, and reliability.

(1) Defect factor analysis: The influence of the process on quality characteristics can be grasped, and factors of yield reduction and quality variation can be identified.

(2) Soft Sensor: Quality characteristics that are difficult to measure or impossible to measure physically can be estimated from the process data.

(3) Control and Adjustment: Certain processes can be controlled and adjusted to achieve desired quality characteristics.

(4) Detection of Abnormality and Change: The prediction error (prediction residual) of the regression model or the change of the regression model itself can be monitored to detect the abnormality and the change.

The regression model is a model that predicts one or more objective variables for a plurality of explanatory variables. The regression model may be any parametric regression model such as a linear regression model, a logistic regression model, a Poisson regression model, a generalized linear regression model, a spline regression model, a generalized additive model, or a neural network. Here, the prediction represents prediction of an objective variable from an explanatory variable, and is not necessarily limited to future forecasting, and may be estimation of a past value.

The objective variable is, for example, a quality characteristic, a defect rate, and a variable indicating whether the product is a non-defective product or a defective product. The objective variable may be a sensor value detected by a sensor. The explanatory variables are other sensor values, setting values, control values, and the like. The explanatory variable may be applied with preprocess in advance. The preprocess is, for example, standardization, normalization, conversion by a specific function, addition of an interaction term, time lag, time lead, dummy variable conversion, encoding, outlier processing, missing value processing, and the like.

Data (such as process data) including the objective variable and the explanatory variable is stored in a data management system, a database, and the like.

First, a case where the regression model has one objective variable will be described. It is assumed that there are n pieces of data in total (n is an integer of 2 or more), and each piece of data includes p explanatory variables and one objective variable. That is, data is represented by (xᵢ, yᵢ), xᵢ ∈R^{p}, yᵢ ∈R, i=1, . . . , n. Here, xᵢ is an explanatory variable of the p-dimensional vector, yᵢ is a scalar objective variable, and R is the entire real number.

At this time, the regression models β₀\hat{ }∈R and β\hat{ }∈R^{p} can be estimated by the least squares method as in the following Equation (1). Note that a variable with a hat symbol “\hat{ }” indicates an estimated value. The same applies to the following variables. In addition, the symbol “T” represents transposition.

$${\hat{β}}_{0} , \hat{β} = {argmin}_{{β}_{0} , β} {{Σ}_{i = 1}^{n} ( {y}_{i} - {\hat{y}}_{i} )}^{2} , {\hat{y}}_{i} = {β}_{0} + {β}^{T} {x}_{i} \qquad ( 1 )$$

In addition, in a case of p>>n, the regression models β₀\hat{ } and β\hat{ } can be estimated by minimizing a square error (an example of a loss function) with L1 regularization as shown in the following Equation (2). Note that λ represents a regularization parameter.

$${\hat{β}}_{0} , \hat{β} = {argmin}_{{β}_{0} , β} \{ {{Σ}_{i = 1}^{n} ( {y}_{i} - {\hat{y}}_{i} )}^{2} + {λΣ}_{j = 1}^{p} \vert {β}_{j} \vert \} , {\hat{y}}_{i} = {β}_{0} + {β}^{T} {x}_{i} \qquad ( 2 )$$

The method shown in the Equation (2) is called Lasso (for example, Tibshirani, R. (1996). Regression shrinkage and selection via the Lasso. Journal of the Royal Statistical Society: Series B (Methodological), 58(1), 267-288.), and many regression coefficients are estimated to be zero, and a sparse regression coefficient is obtained. Therefore, generalization performance in high-dimensional data and interpretability of a model can be improved.

The loss function is not limited to the function representing the square error as described above, and may be any other loss function. In addition, the regularization is not limited to the L1 regularization, and any other regularization may be used.

In quality management such as factories and plants, a regression model does not end once it is constructed. When a predetermined condition is satisfied, it is necessary to reconstruct (update) the regression model. The condition is, for example, one or more conditions defining the timings to perform learning of the regression model, and is, for example, the following condition.
Occurrence of event (maintenance of equipment, change of processing condition, etc.)
Change in process data trend (the value increases, the value decreases, the variation increases, and the like.)
Change in trend of prediction result by regression model (the prediction error becomes large.)

As a method of updating the regression model, a method of collecting new data and estimating the regression model from the beginning can be considered. However, in such a method, problems may occur, such as an increase in the load of calculation processing, an enormous change in the result of variable selection, the unstably-changing regression coefficient, and an increase in the load for checking the regression model.

Therefore, a method of updating the model only in a necessary portion (for example, M. Takada et al., “Transfer Learning via $ell_1$ Regularization”, Advances in Neural Information Processing Systems (NeurIPS2020), 33, 14266-14277., hereinafter, referred to as the method MA) can be utilized. The method MA is a method of estimating and updating a regression model as shown in the following Equation (3) by using a regression model β⁻∈R^{p} before update. Note that α represents a new regularization parameter.

$${\hat{β}}_{0} , \hat{β} = {argmin}_{{β}_{0} , β} \{ {Σ}_{i = 1}^{n} {( {y}_{i} - {\hat{y}}_{i} )}^{2} + {αλΣ}_{j = 1}^{p} \vert {β}_{j} \vert + ( 1 - α ) {λΣ}_{j = 1}^{p} \vert {β}_{j} - {\tilde{β}}_{j} \vert \} , {\hat{y}}_{i} = {β}_{0} + {β}^{T} {x}_{i} \qquad ( 3 )$$

With this formulation, it is possible to realize an update method in which only the minimum necessary parameters are updated and the other parameters are not updated.

When the method MA is used, the parameter to be updated is automatically determined from the data. Therefore, in a case where the noise included in the data is large, in a case where the collinearity of the data is strong, and in a case where the data is high-dimensional, an inappropriate parameter may be updated.

For example, when maintenance is performed on a specific machine, only a parameter (regression coefficient) related to the machine should be updated, but in some cases, a parameter not related to the machine may be updated. In addition, when a specific processing condition is changed, it is desirable to update only parameters related to the processing condition, but other parameters may be updated.

Therefore, in the present embodiment, when a condition (such as occurrence of an event) defining a timing to perform learning (updating) of the regression model is satisfied, a parameter (corresponding to regression coefficient and explanatory variable) that needs to be updated is specified according to the condition, and the specified parameter is preferentially updated. As a result, only necessary portions (parameters) can be more appropriately specified and updated. That is, the regression model can be managed more efficiently.

More specifically, in the present embodiment, a priority of the parameter (explanatory variable) is changed according to the condition, and the regression model is updated on the basis of the priority. As a result, it is possible to stably and efficiently manage (operate) the regression model while realizing the update of the regression model matching the domain knowledge. Hereinafter, an example of using a condition indicating that an event has occurred will be mainly described, but a similar method can be applied to conditions other than the occurrence of an event.

Note that the present embodiment can be applied not only when updating an already constructed regression model but also when newly constructing a regression model. Hereinafter, it is assumed that the learning of the regression model includes both the update of the already constructed (learned) regression model and the construction of the new regression model.

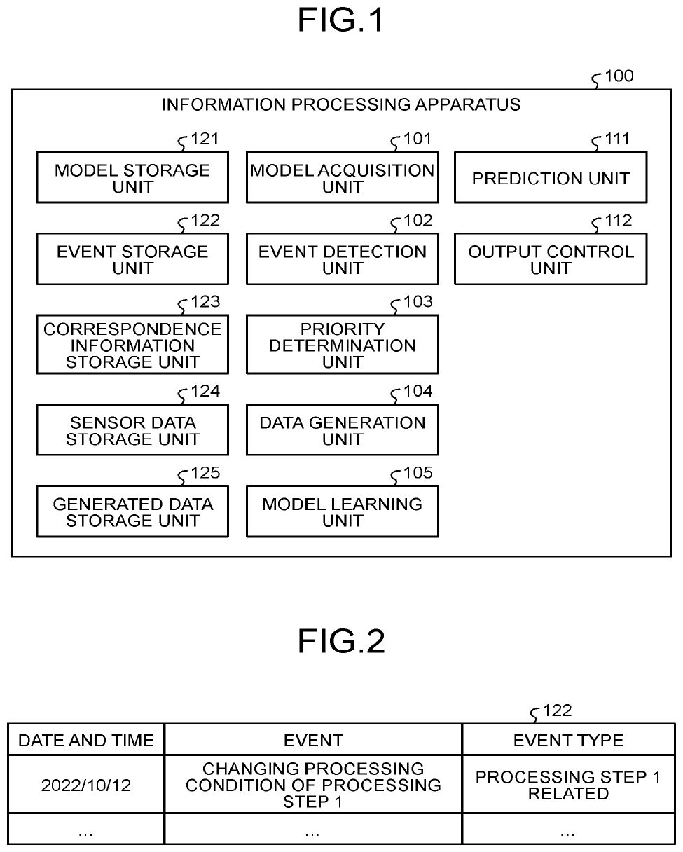

FIG. 1 is a block diagram illustrating an example of a configuration of an information processing apparatus 100 according to an embodiment. As illustrated in FIG. 1, the information processing apparatus 100 includes a model storage unit 121, an event storage unit 122, a correspondence information storage unit 123, a sensor data storage unit 124, a generated data storage unit 125, a model acquisition unit 101, an event detection unit 102 (an example of a detection unit), a priority determination unit 103 (an example of a determination unit), a data generation unit 104, a model learning unit 105 (an example of a learning unit), a prediction unit 111, and an output control unit 112.

The model storage unit 121 stores information related to the regression model such as parameters (regression coefficients and the like) of the regression model. For example, the model storage unit 121 stores information of a regression model learned (constructed or updated) in the past.

The event storage unit 122 stores event information indicating an event that has occurred. FIG. 2 is a diagram illustrating an example of a data structure of event information. As illustrated in FIG. 2, the event information includes date and time, an event, and an event type. The date and time represents the date and time when the event occurred (year/month/date, time, etc.). The event represents an event that has occurred. The event type indicates a type of an event. The event type is set in advance by, for example, an administrator or the like. In FIG. 2, for example, an event of “changing processing condition of processing step 1” is associated with an event type of “processing step 1 related”.

One event may be associated with a plurality of event types. Similarly, one event type may be associated with a plurality of events. That is, an event and an event type may have a one-to-one, one-to-many, many-to-one, and many-to-many relationship.

Returning to FIG. 1, the correspondence information storage unit 123 stores correspondence information to be referred to when the priority determination unit 103 determines a priority. The correspondence information is information in which a condition, an explanatory variable, and a priority are associated with each other. As long as they are associated with each other, the correspondence information may be represented by any structure.

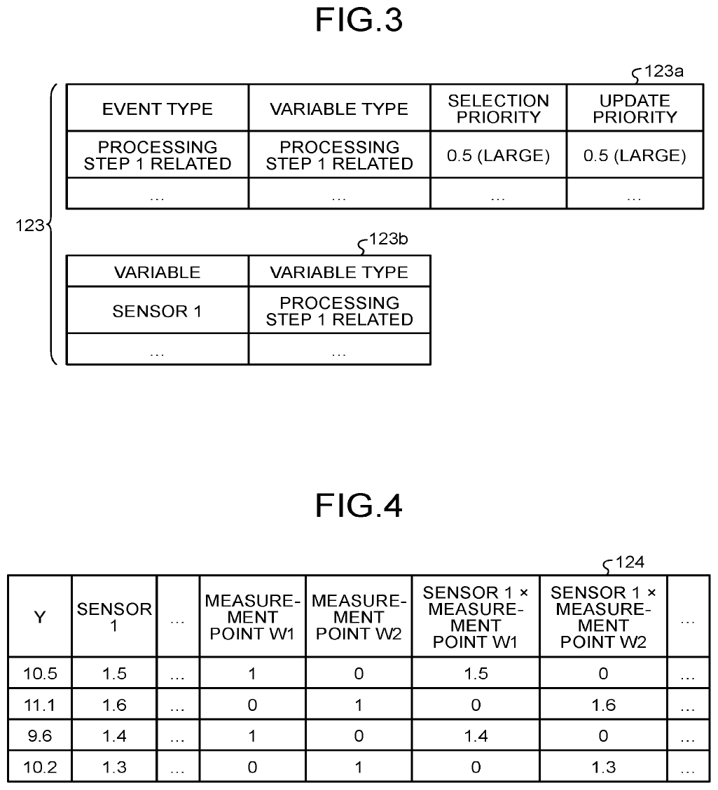

FIG. 3 is a diagram illustrating an example of a data structure of the correspondence information. Note that FIG. 3 is an example in which the correspondence information is managed by being divided into two pieces of correspondence information 123a and correspondence information 123b. The correspondence information may be integrated to be managed in one piece without being divided into two pieces.

As illustrated in FIG. 3, the correspondence information 123a includes an event type, a variable type, a selection priority, and an update priority. In this example, the priority includes two priorities: the selection priority and the update priority. The selection priority represents a priority of selecting the explanatory variable. The update priority represents a priority of updating the explanatory variable.

The selection priority corresponds to, for example, a priority with respect to the second term on the right side of Equation (3) indicating the method MA. This is because the second term is represented by p regression coefficients βⱼ to be estimated corresponding to the p explanatory variables xᵢⱼ (1≤j≤p). The update priority corresponds to, for example, a priority with respect to the third term on the right side of Equation (3). This is because the third term is represented by a difference between the p regression coefficients βⱼ to be estimated and the p regression coefficients β⁻ⱼ estimated last time.

The priority may be any one of the selection priority and the update priority. For example, when Equation (2) is used instead of Equation (3), only the selection priority corresponding to the second term on the right side of Equation (2) may be used.

In the example of the correspondence information 123a of FIG. 3, the event type “processing step 1 related” and the variable type “processing step 1 related” are associated, and for the combination, “0.5 (large)” is associated as the selection priority and “0.5 (large)” is associated as the update priority.

Each priority may be expressed in any way, but may be expressed at a plurality of levels such as “large, medium, small”, or may be expressed by the magnitude of a numerical value.

As illustrated in FIG. 3, the correspondence information 123b includes a variable and a variable type. The variable represents any of the explanatory variables. The variable type of each variable (explanatory variable) is set in advance by, for example, an administrator or the like. In this example, a variable type “processing step 1 related” is associated with a variable “sensor 1”.

By referring to the correspondence information 123a and 123b illustrated in FIG. 3, for example, it is possible to determine the explanatory variable corresponding to the event type of the detected event and the priority (selection priority or update priority). Note that the correspondence information may be interpreted to include the event information in the event storage unit 122. This is because the event type corresponding to the event is specified by the event information.

The event type and the variable type of the correspondence information 123a may have a one-to-one, one-to-many, many-to-one, and many-to-many relationship. Similarly, the variable type and the variable of the correspondence information 123b may have a one-to-one, one-to-many, many-to-one, and many-to-many relationship.

Note that the correspondence information illustrated in FIG. 3 is an example, and the present invention is not limited thereto. For example, the event type and the variable type may be the same as the event and the variable, respectively. In this case, one piece of correspondence information obtained by integrating the correspondence information 123a and the correspondence information 123b, for example, correspondence information in which an event, a variable (explanatory variable), and a priority are associated with each other may be used.

In addition, correspondence information that does not explicitly define the priority may be used. For example, correspondence information in which an event type and a variable type are associated with each other may be used instead of the correspondence information 123a. Alternatively, correspondence information in which an event and a variable are associated with each other may be used instead of the correspondence information 123a and 123b. In this case, different priorities may be determined depending on whether or not it is described in the correspondence information. For example, a high (or low) priority may be determined for a variable described in the correspondence information, and a low (or high) priority may be determined for a variable not described in the correspondence information.

Returning to FIG. 1, the sensor data storage unit 124 stores a plurality of pieces of sensor data detected by various sensors. The sensor data can also be interpreted as data indicating a history of manufacturing in a factory, a plant, or the like.

For example, the sensor data includes one piece of sensor data corresponding to the objective variable and a plurality of pieces of sensor data corresponding to the explanatory variables. As described above, the explanatory variable is not limited to the sensor data (sensor value), and may be a setting value, a control value, or the like. Hereinafter, an example in which sensor data is used as an explanatory variable will be mainly described.

FIG. 4 is a diagram illustrating an example of a data structure of sensor data. In the example of FIG. 4, Y represents sensor data corresponding to the objective variable. The sensor 1 is sensor data measured by a sensor identified by “sensor 1”, and represents sensor data corresponding to an explanatory variable. Although only sensor data from one sensor is shown in FIG. 4, sensor data from two or more sensors may be measured.

Measurement points W1 and W2 are information indicating positions corresponding to the sensor data. In the example of FIG. 4, when the value is “1”, it indicates that the corresponding sensor data (sensor 1) is measured at the measurement point, and when the value is “0”, it indicates that the corresponding sensor data (sensor 1) is not measured at the measurement point.

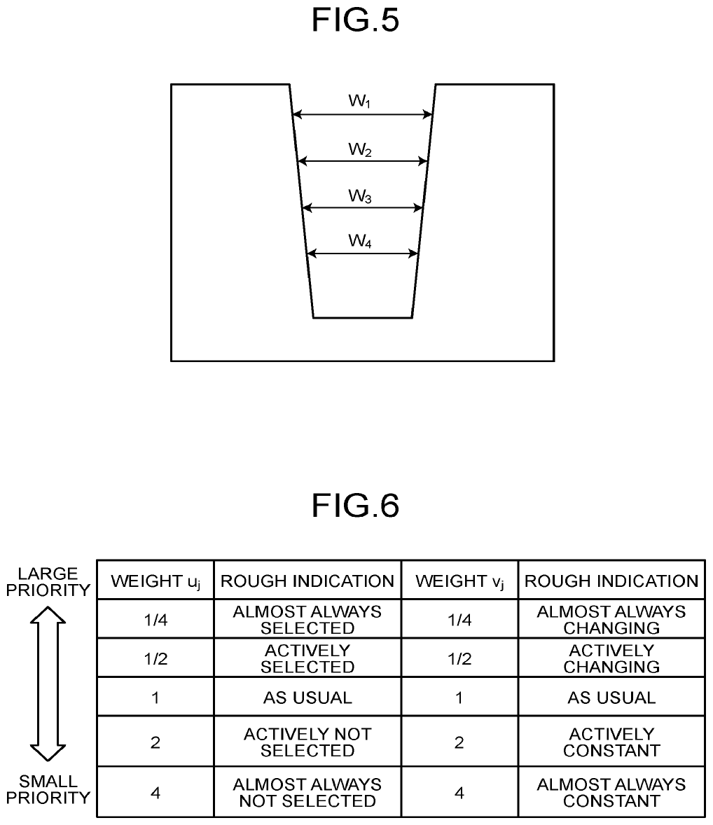

FIG. 5 is a diagram for explaining an example of measurement points. FIG. 5 illustrates an example in which the size of a trench (trench sizes) is measured at a plurality of measurement points when a trench structure (groove or hole) is machined in a semiconductor factory. Further, FIG. 5 is a view of a cross section of the trench as observed from the side. Wk represents the depth at which the width of the trench was measured.

Returning to FIG. 4, a value obtained by multiplying the value of the sensor 1 by the value of the measurement point W1 is set as the sensor 1×the measurement point W1. Similarly, a value obtained by multiplying the value of the sensor 1 by the value of the measurement point W2 is set as the sensor 1×the measurement point W2. In the present embodiment, the value obtained by multiplication in this manner is used as an explanatory variable when performing learning of the regression model.

Note that the sensor data illustrated in FIG. 4 is an example, and the data structure of the sensor data is not limited thereto. For example, the sensor data may have a data structure in which the sensor data measured at each measurement point is set in a column corresponding to each measurement point.

Returning to FIG. 1, the generated data storage unit 125 stores the learning data generated by the data generation unit 104. The learning data is data used for learning the regression model. For example, the learning data is data including a plurality of explanatory variables and one objective variable. Therefore, the sensor data illustrated in FIG. 4 can be used as learning data.

Note that each storage unit (the model storage unit 121, the event storage unit 122, the correspondence information storage unit 123, the sensor data storage unit 124, and the generated data storage unit 125) can be configured by any commonly used storage medium such as a flash memory, a memory card, a random access memory (R-A), a hard disk drive (HDD), and an optical disc.

Each storage unit may be a physically different storage medium or may be realized as different storage areas of physically the same storage medium. Furthermore, each of the storage units may be realized by a plurality of physically different storage media.

The model acquisition unit 101 acquires information regarding the regression model to be learned (constructed and updated) from the model storage unit 121.

The event detection unit 102 detects whether or not one or more conditions defining the timings to perform learning of the regression model are satisfied. For example, the event detection unit 102 detects whether or not a predetermined event has occurred. The detection method may be any method, and for example, the following method can be used.
To detect an input of information indicating occurrence of an event by a user or the like
To detect a notification of occurrence of an event from another system
To inquire of another system whether or not an event has occurred, and detect it by response to the inquiry

The event detection unit 102 may detect that an event has occurred, for example, when event information is stored in the event storage unit 122 by another system or the like. The event detection unit 102 may read the event information stored in the event storage unit 122 periodically or when specified, and detect a predetermined event from the read event information.

The priority determination unit 103 determines the priority of each of the plurality of explanatory variables according to the condition detected to be satisfied. For example, when an event is detected by the event detection unit 102, the priority determination unit 103 determines an explanatory variable related to the event and the priority of the explanatory variable according to the detected event.

The priority determination unit 103 can determine the priority of the explanatory variable by using the event information stored in the event storage unit 122 and the correspondence information (the correspondence information 123a and 123b) stored in the correspondence information storage unit 123. First, the priority determination unit 103 extracts an event type corresponding to the detected event with reference to the event information. The priority determination unit 103 extracts a variable type corresponding to the extracted event type and priority (selection priority or update priority) with reference to the correspondence information 123a. The priority determination unit 103 extracts a variable (explanatory variable) corresponding to the extracted variable type with reference to the correspondence information 123b. The priority determination unit 103 decides the priority corresponding to the variable type of the extracted variable.

In this manner, the priority determination unit 103 determines the priority corresponding to the detected condition (event) for the explanatory variable corresponding to the detected condition (event) by using the correspondence information in which the condition (event), the explanatory variable, and the priority are associated with each other.

The priority determination unit 103 may further determine the priority in consideration of events other than the detected event. For example, the priority determination unit 103 obtains a change of each of the plurality of explanatory variables between the learning data and the test data. The change in the explanatory variable can also be interpreted as a change in the distribution of the explanatory variable. The priority determination unit 103 determines a level of the priority according to the magnitude of the obtained change. For example, the priority determination unit 103 determines the priority of the explanatory variable having change obtained which is larger than the other explanatory variables to be a value larger than the priority of the other explanatory variables. The priority determination unit 103 may determines the priority of the explanatory variable having change obtained which is larger than the other explanatory variables to be a value smaller than the priority of the other explanatory variables.

The test data is data serving as an input of prediction using the regression model after learning. The test data is, for example, sensor data (such as sensor data detected after learning based on the learning data) different from the learning data.

The data generation unit 104 generates learning data. For example, the data generation unit 104 generates part of the sensor data stored in the sensor data storage unit 124 as learning data. In a case where the sensor data is used as it is as the learning data, the generated data storage unit 125 and the data generation unit 104 is not necessarily provided.

The data generation unit 104 may generate the learning data in consideration of the priority. For example, the data generation unit 104 generates learning data including one or more explanatory variables having a higher priority than other explanatory variables among the plurality of explanatory variables and an objective variable. As the priority, for example, a value determined by the priority determination unit 103 before generation of learning data to be used for next learning can be referred to.

The model learning unit 105 performs learning of the regression model using the learning data. When the learning data is generated by the data generation unit 104, the model learning unit 105 performs learning of the regression model using the generated learning data. In addition, the model learning unit 105 performs learning of the regression model so as to optimize the objective function including the regularization term (penalty term) having a regularization strength changing according to the priority. The model learning unit 105 stores information regarding the learned regression model in the model storage unit 121.

Details of learning of the regression model by the model learning unit 105 will be described below. The learning data is represented as (xᵢ,yᵢ), xᵢ ∈R^{p}, yᵢ ∈R, i=1, . . . , n. In addition, a regression model learned in the past is represented as β⁻∈R^{p}. The weight based on the selection priority and the weight based on the update priority are represented as uⱼ and vⱼ (j=1, . . . , p), respectively.

In a case where the selection priority and the update priority are represented by numerical values, the model learning unit 105 can use the numerical value itself or a value calculated using the numerical value as the weight uⱼ and the weight vⱼ. In a case where the selection priority and the update priority are not represented by numerical values, the model learning unit 105 obtains values obtained by converting the selection priority and the update priority into numerical values as the weight uⱼ and the weight vⱼ. The numerical value indicated by the weight is a real number of 0 or more, and it is indicated that the larger the numerical value, the smaller the priority.

FIG. 6 is a diagram illustrating an example of weights. In the example of FIG. 6, the weight uⱼ based on the selection priority is set to any value of ¼, ½, 1, 2, and 4. These values, ¼, ½, 1, 2, and 4, correspond to the explanatory variables being “almost always selected”, “actively selected”, “as usual”, “actively not selected”, and “almost always not selected”, respectively.

Similarly, the weight vⱼ based on the update priority is set to any value of ¼, ½, 1, 2, and 4. These values, ¼, ½, 1, 2, and 4, correspond to the explanatory variables being “almost always changing”, “actively changing”, “as usual”, “actively constant”, and “almost always constant”.

The model learning unit 105 performs learning of the regression model by using learning data (xᵢ, yᵢ), a regression model β⁻, the weight uⱼ, and the weight vⱼ. In the present embodiment, a method (hereinafter, referred to as a method MB) in which a weight based on the priority is added to the method MA is adopted. The method MB is expressed by the following Equation (4).

$${\hat{β}}_{0} , \hat{β} = {argmin}_{{β}_{0} , β} \{ {Σ}_{i = 1}^{n} {( {y}_{i} - {\hat{y}}_{i} )}^{2} + {αλΣ}_{j = 1}^{p} {u}_{j} \vert {β}_{j} \vert + ( 1 - α ) {λΣ}_{j = 1}^{p} {v}_{j} \vert {β}_{j} - {\tilde{β}}_{j} \vert \} , {\hat{y}}_{i} = {β}_{0} + {β}^{T} {x}_{i} \qquad ( 4 )$$

In the method MB, weights uⱼ based on the selection priorities and weights vⱼ based on the update priorities are added to the regularization term as compared with the method MA. The priorities of variable selection and variable update are adjusted by these weights.

As such, in the method MB, the objective function includes the following three terms:
a term evaluating compatibility between a prediction result and correct data: the first term of the right side of Equation (4)
a regularization term (first regularization term) obtained by multiplying terms for regularizing parameters corresponding to explanatory variables by weights based on the selection priorities: the second term on the right side of Equation (4)
a regularization term (second regularization term) obtained by multiplying terms for regularizing changes with respect to parameters before update by weights based on the update priorities: the third term on the right side of Equation (4)

When uⱼ=1 and vⱼ=1 for all the explanatory variables (all j), the method MB matches the method MA.

When the value of uⱼ is large, a large penalty is applied to the fact that the regression coefficient becomes non-zero, and the selection of the variable is suppressed. Similarly, when the value of v is large, a large penalty is applied to the update of the regression coefficient from the regression model β⁻ before the update, and the update of the regression coefficient is suppressed.

Since the priority is adjusted according to the detected event (condition), it is possible to select and update an appropriate explanatory variable for the event. Since only the necessary explanatory variables are selected or only the necessary explanatory variables are updated, for example, an access load to each storage unit, a network load, or a calculation processing load can be reduced. In addition, the model can be stably updated even when the noise is large, when the data collinearity is high, or when the number of data is small. Furthermore, since the model update is consistent with the event information, the management cost for the model update can be reduced.

Note that, in a case of constructing the regression model first, since the learned regression model β⁻ does not exist, the model learning unit 105 may perform learning of the regression model by, for example, a method not using the learned regression model β⁻ as in the above Equation (2).

The prediction unit 111 executes prediction processing using the regression model after learning. For example, the prediction unit 111 executes prediction processing of predicting the objective variable for the test data using the regression model after learning.

The prediction unit 111 may estimate whether or not an object related to the test data is in a specific state (for example, abnormal) using the prediction result (prediction value) of the regression model. The object is for example a specific facility of a factory or plant. The prediction unit 111 may detect the abnormality of the object based on the prediction error of the objective variable predicted using the regression model. The prediction unit 111 estimates that an abnormality has occurred in the object, for example, in a case where the prediction error is larger than the threshold value.

Note that the prediction processing may be executed by an external device (prediction device) of the information processing apparatus 100. In this case, the information processing apparatus 100 does not necessarily include the prediction unit 111.

The output control unit 112 controls output of various types of information used in the information processing apparatus 100. For example, the output control unit 112 outputs a result of the prediction processing by the prediction unit 111. The output method may be any method, and for example, a method of transmitting to an external device via a network and a method of displaying on a display device such as a liquid crystal display can be applied.

At least a part of each unit (the model acquisition unit 101, the event detection unit 102, the priority determination unit 103, the data generation unit 104, the model learning unit 105, the prediction unit 111, and the output control unit 112) may be realized by one processing unit. Each of the above units is realized by, for example, one or a plurality of processors. For example, each of the above units may be realized by causing a processor such as a central processing unit (CPU) and a graphics processing unit (GPU) to execute a program, that is, by software. Each of the above units may be realized by a processor such as a dedicated integrated circuit (IC), that is, hardware. Each of the above units may be realized by using software and hardware in combination. When a plurality of processors is used, each processor may implement one of the units or two or more of the units.

Furthermore, the information processing apparatus 100 may be physically configured by one apparatus or may be physically configured by a plurality of apparatuses. For example, the information processing apparatus 100 may be constructed on a cloud environment.

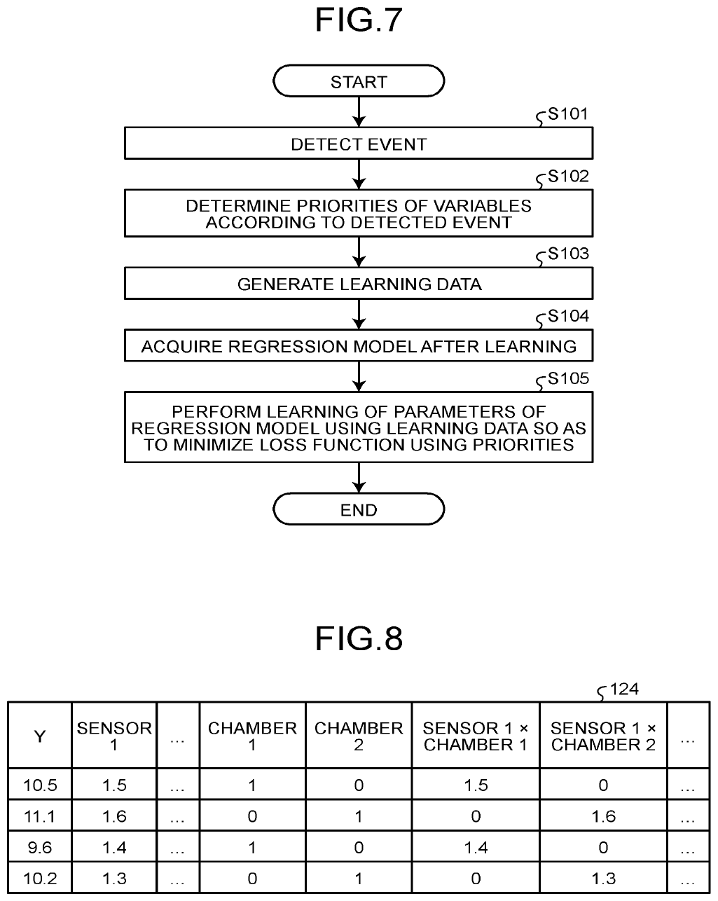

Next, learning processing by the information processing apparatus 100 according to the embodiment will be described. FIG. 7 is a flowchart illustrating an example of learning processing according to the embodiment.

In a case where the event detection unit 102 detects an event, the learning processing is started (Step S101). The priority determination unit 103 determines the priority of the explanatory variable using the correspondence information according to the detected event (Step S102).

The data generation unit 104 generates learning data used for learning of the regression model (Step S103). The model acquisition unit 101 acquires information of the learned regression model from, for example, the model storage unit 121 (Step S104). The model learning unit 105 performs learning of the parameters of the regression model using the learning data generated in Step S103 so as to minimize the objective function using the priority determined in Step S102 (Step S105).

As described above, in the information processing apparatus according to the embodiment, when the condition defining the timing to perform learning of the regression model is satisfied, the priority of the explanatory variable is determined according to the condition, and the regression model is learned using the objective function including the regularization term according to the priority. As a result, the regression model can be managed more efficiently.

### Modification

Many regression models may be required in factories and plants. For example, in a semiconductor factory, not only one product but also various products are produced on the same line, and the tendency is different for each product to be manufactured (variety and model number). In addition, there are various quality characteristics for one product. The quality characteristics in the semiconductor used as the objective variable of the regression model include, for example, an electrical characteristic value and trench sizes. Furthermore, the tendency of these quality characteristics varies depending on the position of a device, a chamber, a wafer, a chip, or the like measured. Therefore, a regression model representing each quality characteristic is required.

Therefore, a technique for constructing an integrated model in which a plurality of regression models is integrated has been proposed. With such a technology, it is possible to estimate the integrated model using a plurality of pieces of data. However, in the conventional technique, since there is no means for updating the constructed model, it is necessary to recreate the integrated model again when the update is necessary. In the method of recreating the integrated model, problems such as an unstable change of the integrated model, a long construction processing (recreating process), and an increased burden on a worker for construction or verification may occur.

An integrated model obtained by integrating a plurality of regression models can be interpreted as a model that predicts a plurality of objective variables. Therefore, in the modification, an example of managing a regression model that predicts a plurality of objective variables will be described. Basically, learning (constructing, or updating) of the regression model can be performed by a method similar to that of the above embodiment.

An example of a plurality of regression models will be described. Assuming that there are K objective variables (K is an integer of 2 or more), data including the objective variable and the explanatory variable is represented by (xᵢ, yᵢ), xᵢ ∈R^{p}, yᵢ ∈R^{K}, i=1, . . . , n. The regression model is estimated as the following Equation (5).

$${\hat{β}}_{0 k} , {\hat{β}}_{k} = {argmin}_{{β}_{0} , β} {{Σ}_{i = 1}^{n} ( {y}_{ik} - {\hat{y}}_{ik} )}^{2} , {\hat{y}}_{ik} = {β}_{0 k} + {β}_{k}^{T} {x}_{i} , k = 1 , … , K \qquad ( 5 )$$

There are K regression models, and the number of regression coefficients (the number of parameters) including the intercept is (p+1)×K. In this way, when each of the plurality of regression models is individually constructed, the number of regression coefficients becomes enormous, and construction and management thereof become complicated.

Therefore, by introducing sparsity, the number of parameters is reduced to improve and stabilize generalization performance.

For example, when there are K types of objective variables, a K-dimensional dummy variable zᵢ ∈{0, 1}^{K} representing the type of i-th data is introduced. This dummy variable is dummy variable conversion called one-hot encoding of the categorical variable, but K−1 dimensional dummy variable conversion may be used, or another encoding method may be used.

The category variable is a variable that can take a plurality of levels (values) for a certain category. The category and the level may be any combination, and for example, the following combination can be used.
(A1) Category: measurement position in trench, Level: depth (in the example of FIG. 5, levels of W1 to W44)
(A2) Category: measurement position in wafer, Level: three levels of top, center, bottom, etc.
(A3) Category: object to be measured, Level: device, chamber, etc.

The dummy variable conversion is executed, for example, as follows.
Each level is converted into a dummy variable for any of the plurality of categories.
Each level is converted into a dummy variable for a combination of the plurality of categories.
Each of the plurality of categories is converted into a dummy variable.

At this time, assuming that a regression coefficient common to types and an intercept different for each type are provided, the regression model is expressed by the following Equation (6).

$${\hat{y}}_{i} = {β}_{0 k} + {β}^{T} {x}_{i} + {γ}^{T} {z}_{i} \qquad ( 6 )$$

Here, γ^{T}∈R^{K}, and the k-th element γₖ represents an intercept when the type of the objective variable is k. As a result, the number of parameters is (1+p+K). Furthermore, if the regression coefficient is different for each type, a model represented by the following Equation (7) can be considered as the regression model.

$${\hat{y}}_{i} = {β}_{0 k} + {β}^{T} {x}_{i} + {γ}^{T} {z}_{i} + {Σ}_{k = 1}^{K} {Σ}_{j = 1}^{p} {δ}_{jk} {x}_{ij} {z}_{ik} \qquad ( 7 )$$

At this time, the number of parameters is (1+p+K+pK). Although the number of parameters increases as it is, the number of effective parameters can be reduced by estimating many parameters to zero by adding appropriate regularization as shown in the following Equation (8) (for example, Tibshirani, R., & Friedman, J. (2020). “A pliable Lasso.” Journal of Computational and Graphical Statistics, 29(1), 215-225.).

$${\hat{β}}_{0} , \hat{β ,} \hat{y} , δ = {argmin}_{{β}_{0} , β , γ , δ} \{ {{Σ}_{i = 1}^{n} ( {y}_{ik} - {\hat{y}}_{ik} )}^{2} + ( 1 - α ) {λΣ}_{j = 1}^{p} ( \sqrt{{β}_{j}^{2} + {Σ}_{k = 1}^{K} {δ}_{jk}^{2}} + \sqrt{{Σ}_{k = 1}^{K} + {δ}_{jk}^{2}} ) + {αλΣ}_{k = 1}^{K} {Σ}_{j = 1}^{p} \vert {δ}_{jk} \vert \} \qquad ( 8 )$$

Here, the first term of the objective function corresponding to the right side of Equation (8) is a square error, the second term is a term (regularization term) sparsifying the common regression coefficient and the individual regression coefficient with each variable j, and the third term is a term (regularization term) sparsifying the individual regression coefficient.

In particular, the second term is a formulation that constrains “γⱼₖ may be non-zero only when βⱼ is non-zero (there is almost no case where βⱼ is zero even though γⱼₖ is non-zero)”. By using such regularization, effective (non-zero) parameters are reduced, and generalization performance, stabilization, and interpretability can be improved.

Such a method is also called multi-task learning in the sense that there are a plurality of objective variables, and various methods other than the above have been proposed (for example, Japanese Patent No. 6480022, Yuan, M., & Lin, Y. (2006). “Model selection and estimation in regression with grouped variables.” Journal of the Royal Statistical Society: Series B (Statistical Methodology), 68(1), 49-67., Obozinski, G., Wainwright, M. J., & Jordan, M. I. (2008). “High-dimensional union support recovery in multivariate regression.” Advances in Neural Information Processing Systems, 21(3)., Lee, S., Zhu, J., & Xing, E. (2010). “Adaptive multi-task Lasso: with application to eqtl detection.” Advances in neural information processing systems, 23., and Zhang, K., Zhe, S., Cheng, C., Wei, Z., Chen, Z., Chen, H., . . . & Ye, J. (2016, August). “Annealed sparsity via adaptive and dynamic shrinking.” In Proceedings of the 22nd ACM SIGKDD International Conference on Knowledge Discovery and Data Mining (pp. 1325-1334).).

In addition, such a method can be interpreted as newly expanding the learning data (xᵢⱼ, zᵢₖ, xᵢⱼzᵢₖ) using the dummy variable with respect to the original learning data (xᵢⱼ) and estimating the integrated regression model using the sparse regularization with respect to the expanded learning data.

For example, zᵢ₁ is a variable representing whether or not the objective variable is the quality characteristic of a chamber 1 as one or zero, and xᵢ₁ is a variable of the sensor 1. In this case, the new variable xᵢ₁zᵢ₁ is a variable representing “sensor 1×chamber 1”, and is a variable representing a value of zero in a case other than the chamber 1 and a variable representing the value of the sensor 1 itself in a case of the chamber 1.

That is, by extending the data, an integrated model in which a plurality of regression models is integrated can be constructed. In implementing the algorithm, if the learning data is extended as preprocessing, a method and a package of a general regularized optimization problem can be used.

FIG. 8 is a diagram illustrating an example of a data structure of sensor data used in the modification. FIG. 8 illustrates an example of sensor data extended by the method as described above.

Y represents sensor data (such as quality characteristics) corresponding to the objective variable. The sensor 1 is sensor data measured by a sensor identified by “sensor 1”. “Chamber 1” and “chamber 2” correspond to dummy variables representing the type of Y that is an objective variable. For example, when the value of “chamber 1” is one, it indicates that a semiconductor product is manufactured in a chamber corresponding to “chamber 1”. When the value of “chamber 2” is one, it indicates that a semiconductor product is manufactured in a chamber corresponding to “chamber 2”. That is, this example can be interpreted as an example of data for an integrated model for predicting two quality characteristics of products manufactured in two different chambers. In this integrated model, the two quality characteristics are represented by one objective variable Y.

The data extension is executed by the data generation unit 104, for example. That is, the data generation unit 104 calculates a plurality of explanatory variables by multiplying one or more variables VA (first variables) and a plurality of dummy variables respectively corresponding to the plurality of objective variables. In the example of FIG. 8, for example, sensor data measured by the “sensor 1” corresponds to the variable VA. Further, “chamber 1” and “chamber 2” correspond to the plurality of dummy variables. The data generation unit 104 generates data including the calculated plurality of explanatory variables.

In the modification, the learning method of the integrated model similar to that of the above embodiment is applied by regarding the explanatory variable and the regression model (integrated model) of the extended data as the p-dimension. For example, in the example of FIG. 8, the variable “sensor 1×chamber 1” expanded as the variable unique to the chamber 1 and the variable “sensor 1×chamber 2” expanded as the variable unique to the chamber 2 are interpreted as at least a part of the p-dimensional explanatory variable.

It may be necessary to update the model even for the integrated model constructed as described above. In particular, since the integrated model targets a plurality of quality characteristics, the frequency of updating the model of the integrated model is higher than that of the regression model of one quality characteristic.

For the update of the integrated model, the method MA for updating only necessary portions can be utilized. In order to apply the method MA to the integrated model, the data may only be expanded in advance by setting a vector in which xᵢⱼ, zᵢₖ, and xᵢ zᵢₖ (j=1, . . . , p, k=1, . . . , K) are arranged as xᵢ afresh.

However, since the integrated model includes a plurality of quality characteristics, noise tends to be large, and a dimension of data often becomes large, so that automatic parameter update by the method MA is not always necessarily appropriate.

Therefore, in the present modification, when a condition (such as occurrence of an event) defining a timing to perform learning (updating) of the integrated model is satisfied, a parameter that needs to be updated is specified according to the condition, and the specified parameter is preferentially updated.

An example of a priority determination method according to a modification will be described.

Also in the modification, the priority determination unit 103 can determine the priority of the explanatory variable using the event information stored in the event storage unit 122 and the correspondence information (the correspondence information 123a and 123b) stored in the correspondence information storage unit 123.

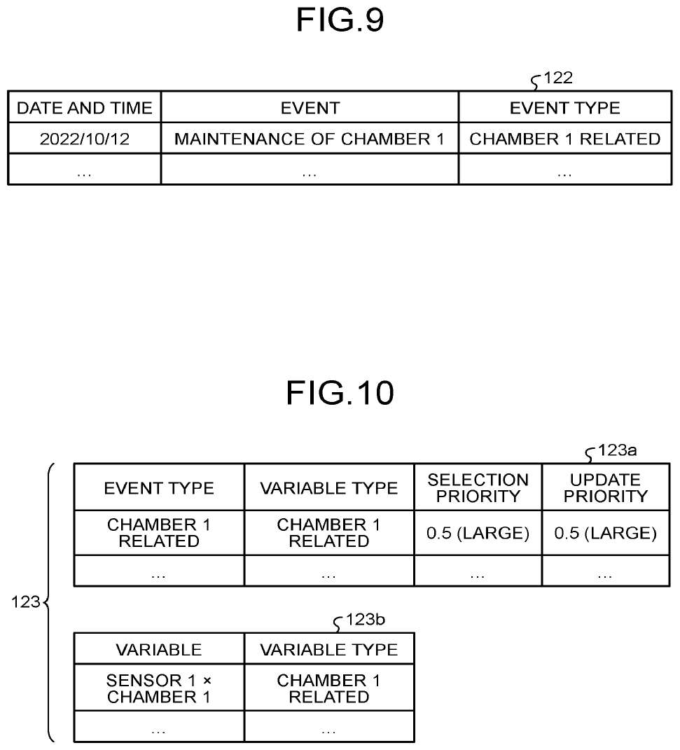

FIG. 9 is a diagram illustrating an example of a data structure of event information used in the modification. In FIG. 9, for example, an event of “maintenance of chamber 1” is associated with an event type of “chamber 1 related”.

FIG. 10 is a diagram illustrating an example of a data structure of the correspondence information used in the modification. In the example of the correspondence information 123a of FIG. 10, the event type “chamber 1 related” and the variable type “chamber 1 related” are associated, and for the combination, “0.5 (large)” is associated as the selection priority and “0.5 (large)” is associated as the update priority. In the example of the correspondence information 123b in FIG. 10, a variable type of “chamber 1 related” is associated with a variable “sensor 1×chamber 1” expanded as a variable unique to the chamber 1.

The correspondence information 123b between the variable and the variable type may be manually set by, for example, an administrator or the like. The correspondence information 123b may be generated by, for example, the priority determination unit 103 (or the data generation unit 104, the model learning unit 105, or the like may be used) with reference to the extended data.

For example, the priority determination unit 103 specifies the type of the objective variable corresponding to the dummy variable. In the example of FIG. 8, for the dummy variable “chamber 1”, the priority determination unit 103 specifies that the type of the objective variable is “chamber 1 related”. The priority determination unit 103 specifies the specified type of the objective variable as the type (variable type) of the explanatory variable. The priority determination unit 103 generates the correspondence information 123b (first correspondence information) in which the specified type of the explanatory variable is associated with the explanatory variable.

As a result, the priority determination unit 103 can determine the priority corresponding to the type of the detected condition for the explanatory variable included in the variable type corresponding to the type of the detected condition (event type) using the generated correspondence information 123b and the correspondence information 123a (second correspondence information).

The priority determination unit 103 may further determine the priority in consideration of the prediction error of the prediction processing by the model after learning. For example, the priority determination unit 103 determines the level of the priority of the corresponding explanatory variable according to the magnitude of the prediction error by the regression model after learning among the plurality of objective variables. For example, when the prediction error of the quality characteristic (objective variable) related to the chamber 2 is larger than other quality characteristics (for example, the quality characteristic related to the chamber 1), the priority determination unit 103 determines the priority of the explanatory variable (for example, the sensor 1×the chamber 2) related to the quality characteristic (objective variable) related to the chamber 2 to be a value larger than other explanatory variables. Conversely, the priority determination unit 103 may determine the priority of the explanatory variable having the prediction error larger than the other explanatory variables to be a value smaller than the priority of the other explanatory variables.

The model learning unit 105 perform learning of the regression model so as to optimize the objective function including the regularization term (penalty term) having a regularization strength changing according to the priority determined. As described above, in the modification, the learning method of the integrated model (regression model) similar to the above embodiment can be applied by regarding the explanatory variable of the extended data as the p-dimensional learning data xᵢ afrsh.

As described above, in the modification, even for an integrated model having a plurality of quality characteristics, the model is updated by changing the priority according to the event, so that the model can be stably updated and the load on the update of the model can be reduced and efficiently managed.

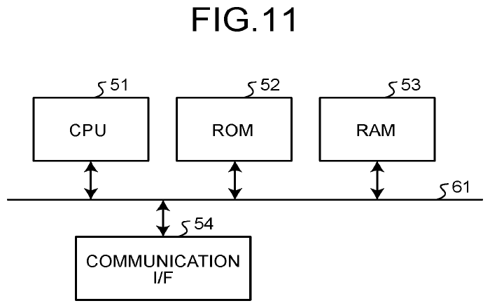

Next, a hardware configuration of an information processing apparatus according to the embodiment (and the modification) will be described with reference to FIG. 11. FIG. 11 is a diagram illustrating a hardware configuration example of the information processing apparatus according to the embodiment.

The information processing apparatus according to the embodiment includes a control device such as a CPU 51, a storage device such as a read only memory (ROM) 52 and a RAM 53, a communication I/F 54 that is connected to a network and performs communication, and a bus 61 that connects the respective units.

The program executed by the information processing apparatus according to the embodiment is provided by being incorporated in the ROM 52 or the like in advance.

The program executed by the information processing apparatus according to the embodiment may be provided as a computer program product by being recorded as a file in an installable format or an executable format in a computer-readable recording medium such as a compact disk read only memory (CD-ROM), a flexible disk (FD), a compact disk recordable (CD-R), or a digital versatile disk (DVD).

Furthermore, the program executed by the information processing apparatus according to the embodiment may be stored on a computer connected to a network such as the Internet and provided by being downloaded via the network. Furthermore, the program executed by the information processing apparatus according to the embodiment may be provided or distributed via a network such as the Internet.

The program executed by the information processing apparatus according to the embodiment can cause a computer to function as each unit of the information processing apparatus described above. In this computer, the CPU 51 can read a program from a computer-readable storage medium onto a main storage device and execute the program.

A configuration example of the embodiment will be described below:

### Configuration Example 1

An information processing apparatus including
a processing unit configured to:
   detect whether or not one or more conditions defining timings to perform learning of a regression model configured to predict one or more objective variables for a plurality of explanatory variables are satisfied;
   determine priorities of the plurality of explanatory variables according to a condition detected to be satisfied; and
   perform learning of the regression model by using an objective function and learning data, the objective function including a regularization term having a regularization strength changing according to the priorities.

### Configuration Example 2

The information processing apparatus according to Configuration Example 1, wherein
the regression model is configured to predict a plurality of objective variables, and
the processing unit is configured to:
   calculate the plurality of explanatory variables by multiplying one or more first variables and a plurality of dummy variables corresponding to the plurality of objective variables, and generate the learning data including the plurality of calculated explanatory variables; and
   perform learning of the regression model using the generated learning data.

### Configuration Example 3

The information processing apparatus according to Configuration Example 2, wherein
the processing unit is configured to:
   specify a type of objective variable corresponding to a dummy variable as a type of explanatory variable, and generate first correspondence information in which the specified type of explanatory variable and the explanatory variable are associated with each other; and
   determine a priority corresponding to a type of the detected condition for the explanatory variable included in the type of explanatory variable corresponding to the type of the detected condition by using the first correspondence information and second correspondence information in which the type of condition, the type of explanatory variable, and the priority are associated with each other.

### Configuration Example 4

The information processing apparatus according to Configuration Example 2, wherein
the processing unit is configured to
   determine a priority of an explanatory variable corresponding to an objective variable according to a magnitude of a prediction error by the regression model after learning among the plurality of objective variables.

### Configuration Example 5

The information processing apparatus according to any one of Configuration Examples 1 to 4, wherein
the processing unit is configured to
   determine a priority corresponding to the detected condition for an explanatory variable corresponding to the detected condition by using correspondence information in which the condition, the explanatory variable, and the priority are associated with each other.

### Configuration Example 6

The information processing apparatus according to any one of Configuration Examples 1 to 5, wherein
the processing unit is configured to:
   generate the learning data including one or more explanatory variables having priorities higher than another explanatory variable among the plurality of explanatory variables, and one or more objective variables; and
   perform learning of the regression model using the generated learning data.

### Configuration Example 7

The information processing apparatus according to any one of Configuration Examples 1 to 6, wherein
the processing unit is configured to
   obtain changes of the plurality of explanatory variables between the learning data, and test data serving as an input in prediction using the regression model after learning, and determine the priorities of the plurality of explanatory variables according to magnitudes of the changes.

### Configuration Example 8

The information processing apparatus according to any one of Configuration Examples 1 to 7, wherein
the priorities include selection priorities representing priorities of selecting the plurality of explanatory variables and update priorities representing priorities of updating the plurality of explanatory variables, and
the objective function includes:
   a term evaluating compatibility between a prediction result and correct data;
   a first regularization term obtained by multiplying terms for regularizing parameters corresponding to the plurality of explanatory variables by weights based on the selection priorities; and
   a second regularization term obtained by multiplying terms for regularizing changes with respect to the parameters before update by weights based on the update priorities.

### Configuration Example 9

The information processing apparatus according to any one of Configuration Examples 1 to 8, wherein
the processing unit is configured to
   predict the one or more objective variables for test data including the plurality of explanatory variables using the regression model after learning.

### Configuration Example 10

The information processing apparatus according to Configuration Example 9, wherein
the processing unit is configured to
   estimate whether or not an object related to the test data is in a specific state based on a prediction error of the predicted objective variables.

### Configuration Example 11

The information processing apparatus according to any one of Configuration Examples 1 to 10, wherein
the processing unit is configured to
   perform learning of the regression model using the learning data so as to optimize the objective function.

### Configuration Example 12

The information processing apparatus according to any one of Configuration Examples 1 to 11, wherein
the processing unit includes:
   a detection unit configured to detect whether or not the one or more conditions are satisfied;
   a determination unit configured to determine the priorities; and
   a learning unit configured to perform learning of the regression model.

### Configuration Example 13

An information processing method executed by an information processing apparatus, the method including:
detecting whether or not one or more conditions defining timings to perform learning of a regression model that predicts one or more objective variables for a plurality of explanatory variables are satisfied;
determining priorities of the plurality of explanatory variables according to a condition detected to be satisfied; and
performing learning of the regression model by using an objective function and learning data, the objective function including a regularization term having a regularization strength changing according to the priorities.

### Configuration Example 14

A program causing a computer to execute:
detecting whether or not one or more conditions defining timings to perform learning of a regression model that predicts one or more objective variables for a plurality of explanatory variables are satisfied;
determining priorities of the plurality of explanatory variables according to a condition detected to be satisfied; and
performing learning of the regression model by using an objective function and learning data, the objective function including a regularization term having a regularization strength changing according to the priorities.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising
a processing unit configured to:
detect whether or not one or more conditions defining timings to perform learning of a regression model configured to predict one or more objective variables for a plurality of explanatory variables are satisfied;
determine priorities of the plurality of explanatory variables according to a condition detected to be satisfied; and
perform learning of the regression model by using an objective function and learning data, the objective function including a regularization term having a regularization strength changing according to the priorities.

2. The apparatus according to claim 1, wherein
the regression model is configured to predict a plurality of objective variables, and
the processing unit is configured to:
calculate the plurality of explanatory variables by multiplying one or more first variables and a plurality of dummy variables corresponding to the plurality of objective variables, and generate the learning data including the plurality of calculated explanatory variables; and
perform learning of the regression model using the generated learning data.

3. The apparatus according to claim 2, wherein
the processing unit is configured to:
specify a type of objective variable corresponding to a dummy variable as a type of explanatory variable, and generate first correspondence information in which the specified type of explanatory variable and the explanatory variable are associated with each other; and
determine a priority corresponding to a type of the detected condition for the explanatory variable included in the type of explanatory variable corresponding to the type of the detected condition by using the first correspondence information and second correspondence information in which the type of condition, the type of explanatory variable, and the priority are associated with each other.

4. The apparatus according to claim 2, wherein
the processing unit is configured to
determine a priority of an explanatory variable corresponding to an objective variable according to a magnitude of a prediction error by the regression model after learning among the plurality of objective variables.

5. The apparatus according to claim 1, wherein
the processing unit is configured to
determine a priority corresponding to the detected condition for an explanatory variable corresponding to the detected condition by using correspondence information in which the condition, the explanatory variable, and the priority are associated with each other.

6. The apparatus according to claim 1, wherein
the processing unit is configured to:
generate the learning data including one or more explanatory variables having priorities higher than another explanatory variable among the plurality of explanatory variables, and one or more objective variables; and
perform learning of the regression model using the generated learning data.

7. The apparatus according to claim 1, wherein
the processing unit is configured to
obtain changes of the plurality of explanatory variables between the learning data, and test data serving as an input in prediction using the regression model after learning, and determine the priorities of the plurality of explanatory variables according to magnitudes of the changes.

8. The apparatus according to claim 1, wherein
the priorities include selection priorities representing priorities of selecting the plurality of explanatory variables and update priorities representing priorities of updating the plurality of explanatory variables, and
the objective function includes:
a term evaluating compatibility between a prediction result and correct data;
a first regularization term obtained by multiplying terms for regularizing parameters corresponding to the plurality of explanatory variables by weights based on the selection priorities; and
a second regularization term obtained by multiplying terms for regularizing changes with respect to the parameters before update by weights based on the update priorities.

9. The apparatus according to claim 1, wherein
the processing unit is configured to
predict the one or more objective variables for test data including the plurality of explanatory variables using the regression model after learning.

10. The apparatus according to claim 9, wherein
the processing unit is configured to
estimate whether or not an object related to the test data is in a specific state based on a prediction error of the predicted objective variables.

11. The apparatus according to claim 1, wherein
the processing unit is configured to
perform learning of the regression model using the learning data so as to optimize the objective function.

12. The apparatus according to claim 1, wherein
the processing unit comprises:
a detection unit configured to detect whether or not the one or more conditions are satisfied;
a determination unit configured to determine the priorities; and
a learning unit configured to perform learning of the regression model.

13. An information processing method executed by an information processing apparatus, the method comprising:
detecting whether or not one or more conditions defining timings to perform learning of a regression model that predicts one or more objective variables for a plurality of explanatory variables are satisfied;
determining priorities of the plurality of explanatory variables according to a condition detected to be satisfied; and
performing learning of the regression model by using an objective function and learning data, the objective function including a regularization term having a regularization strength changing according to the priorities.

14. A computer program product comprising a computer-readable medium including programmed instructions, the instructions causing a computer to execute:
detecting whether or not one or more conditions defining timings to perform learning of a regression model that predicts one or more objective variables for a plurality of explanatory variables are satisfied;
determining priorities of the plurality of explanatory variables according to a condition detected to be satisfied; and
performing learning of the regression model by using an objective function and learning data, the objective function including a regularization term having a regularization strength changing according to the priorities.
